(19) United States
(12) Patent Application Publication
(10) Pub. No.: US 2010/0023424 A1
(43) Pub. Date: Jan. 28, 2010

(54) ONLINE MARKETPLACE FOR INTELLECTUAL PROPERTY

(75) Inventor: Christophe J. P. Sevrain, Bloomfield Hills, MI (US)

Correspondence Address: REISING ETHINGTON P.C., P O BOX 4390, TROY, MI, 48099-4390, US

(73) Assignee: CJPS Enterprises, LLC, Troy, MI (US)

(21) Appl. No.: 12/575,912

(22) Filed: Oct. 8, 2009

Related U.S. Application Data
(63) Continuation-in-part of application No. 12/036,601, filed on Feb. 25, 2008.
Application No. 12/036,601 is a continuation-in-part of application No. 11/937,689, filed on Nov. 9, 2007, now abandoned.
(60) Provisional application No. 60/950,183, filed on Jul. 17, 2007.

(51) Int. Cl. G06Q 30/00; G06Q 50/00

(52) U.S. Cl. 705/26

(57) ABSTRACT

A method for providing an internet network based marketplace for IP assets comprises the steps of producing a list of IP assets which a poster wishes to license or sell, and making the list of IP assets accessible to the network to viewers interested in licensing or acquiring one or more items on the list of IP in a controlled format, wherein the list of IP assets may be uploaded from a poster via a transfer of data over the internet. Either the poster or the viewer may be alerted in response to alert criteria about information pertaining to the list of IP.

This patent application is a Continuation-in-Part of U.S. patent application Ser. No. 12/036,601,filed Feb. 25, 2008, which is a Continuation-in-Part of U.S. patent application Ser. No. 11/937,689, filed on Nov. 9, 2007, which claims priority benefit of U.S. provisional patent application No. 60/950,183 filed on Jul. 17, 2007.

### BACKGROUND ART

1. Field of the Invention

This invention relates to an online marketplace. More particularly, this invention relates to an online marketplace having a database structure unique in its design for intellectual property.

2. Description of the Related Art

Intellectual property (especially patents and trade secrets but also copyrights trademarks, design and plant patents, etc.) form an increasingly important part of the balance sheets of many companies. Intellectual property (IP) can be the basis for obtaining and securing market share in an industry, and the basis for license agreements and joint ventures and other technology sharing arrangements.

As IP assets can be bought, licensed and sold, it is not necessary to be the inventor/creator or the initial owner of an IP asset in order to commercialize it. In fact, in many instances the inventor/creator or initial owner is not in a position to effectively commercialize a technology without help. Examples of this situation include situations where the inventor is the owner and an individual without significant resources; a university whose primary function is knowledge dissemination instead of commercialization of faculty/employee inventions; corporations which need IP to obtain freedom to operate in a given area of technology; and corporations which perceive more value in developing other areas, or compete in one field and are willing to license the technology into another non-competing field.

Various public and private subscription-based databases of patents and published patent applications are known, such as www.uspto.gov and www.delphion.com, for example. These databases provide, however, only the information about the published documents in question and do not include non-published IP, such as trade secrets, provisional patent applications, even inventions merely at the inventions disclosure stage prior to any filing, nor any other confidential information. Nor do such published patent documents effectively communicate the underlying commercial value of the IP asset, since that is not their intended function, nor do they indicate a field of use where a license might be available, nor do they provide direct information about who to contact if a buyer/licensee wants to contact the owner of the IP asset.

Some attempts have been made to try to commercialize IP assets. For example, IP bid method and system, U.S. Patent Publication 2002/0082973, Marbach, et al. disclose a method, system, and computer program product for auctioning IP. An IP owner identifies property to be placed at auction. The owner further defines license information including a license right type, a business right type, and an IP use type, which taken together with the property determines eight minimum bid amounts. The method and system sends the bidder a bid form prompting the bidder to enter in the above mentioned information, and the bidders contact information. Upon receipt, the system registers the bidder and sends the validated bid amount information, not including the bidder's registration information, to the owner for evaluation and selection of the winning bidder. All received bids are maintained in confidence until the winning bidders are contacted at the auction's conclusion, while all non-winning bids are deleted. Auction systems such as those disclosed in Marbach et al for selling IP assets have significant limitations because they presuppose a plurality of bidders. In many situations however, there may only be one bidder for a particular IP asset.

In some instances the poster/licensor and/or buyer/licensee may be interested in controlling or preventing complete information from being presented to the other party. Also, IP assets may be purchased outright or licensed in particular fields of use, and auction systems have difficulty accommodating varying demands of disparate buyers and licensees.

Another problem is that all the IP in a given area may be scattered among different owners and not easy to track down. For example multiple universities and companies may have patents and patent applications on the same area of research. All of them may be interested in selling or licensing their technology. It would be desirable to provide a single convenient website where owners of IP may post the assets they wish to sell and license, and where buyers and licensees of IP may view such assets. It would also be desirable to provide an easier way for potential posters and licensors of IP to upload many (hundreds or thousands) pieces of IP that they want to upload at once. It would also be desirable to provide a way for posters and buyers of IP to be notified when IP that they want to look at (or when someone is looking at their posted IP) is available.

### SUMMARY OF THE INVENTION

A method creates a marketplace for a plurality of intellectual property assets defined by a number of characteristics. The method begins by receiving a portion of the plurality of intellectual property assets. Each of the portion of the plurality of intellectual property assets are associated with a poster. A portion of the characteristics for the portion of the plurality of intellectual property assets is identified. The characteristics of the portion of the plurality of intellectual property assets are modified to create marketing information. The marketing information for the portion of the plurality of intellectual property assets is then posted in a single location such that a buyer interested in obtaining rights in any of plurality of the intellectual property assets may view the plurality of intellectual property assets by marketing information.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a schematic flow chart of a marketplace for listing IP available for licensing and/or sale in accordance with a preferred embodiment;

FIG. 2 shows an IP Listing Module of the marketplace described in FIG. 1;

FIG. 3 shows an IP Searching Module of the marketplace described in FIG. 1;

FIG. 4 shows an additional Support Module of the marketplace described in FIG. 1; and

FIG. 5 shows sample screenshot where a poster/poster of IP may post registration information and post more specific information about the IP he wishes to sell or license.

### DETAILED DESCRIPTION OF THE PREFERRED EMBODIMENTS

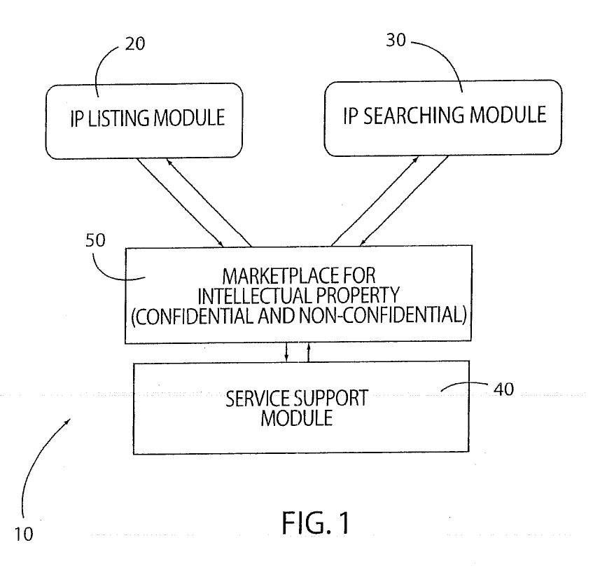

Referring now to the drawings, FIG. 1 shows a representative schematic flow chart 10 representing a marketplace 50 for posting IP available for sale and for buying or licensing that IP. In accordance with a highly advantageous feature, IP assets which may be identified and posted to the marketplace can comprise, for example, not only patents, published pending patent applications, design patents, plant patents, copyrights, trademarks, etc., (i.e., non-confidential information) but also unpublished IP such as unpublished utility patent applications (principally those less than 18 months old under current law), invention disclosures and summary descriptions of trade secrets (Confidential Information). Trade secrets may be posted in summary description form so as not to disclose the secret or, in some instances, the entire secret if a partial revelation is acceptable in a particular situation. For example, an improved method of manufacturing a chemical may be indicated in terms of results (50% higher yields) rather than in terms of the steps or recipe associated with the manufacturing process that generates the desirable result.

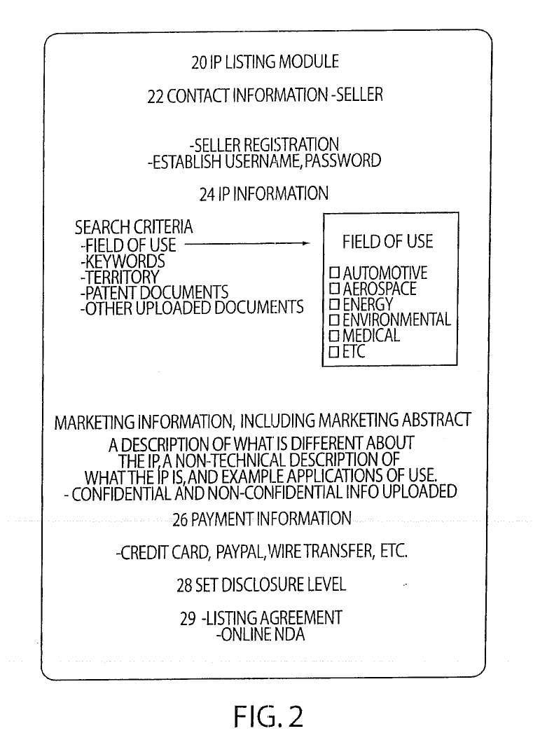

Whatever the type of IP, a person on his own behalf or the behalf of an entity (the “poster”) will post the IP to a marketplace 50. Typically the marketplace would be a website accessible by remote buyers, posters, support staff, administrative staff and other users. As used herein, a poster is the person or entity that is contemplating the shedding of rights in the posted IP whereas the “buyer” as used herein is the person or entity that is looking to acquire rights in posted IP. The rights may be in the form of a complete sale or a license arrangement, or any variation therebetween. A poster lists his IP at the IP listing module 20 shown in FIG. 2. The poster can comprise, for example, universities interested in licensing or selling their inventions, corporations that either are willing to sell its IP or license the IP in certain fields of use, individuals with limited marketing resources, and other institutions. The listing process includes the steps of Poster Registration, where the poster provides contact information 22 and is given a username and password. Typically, this information is generated by presenting a series of screens at the website for the poster to complete. Preferably, the poster of the IP is charged a fee for posting IP assets. This fee can vary depending upon the number of assets uploaded to the marketplace 50, and can be modified or even waived as desired by an operator of the IP marketplace website. Payment information 26 is collected from the poster. Paypal® or other known techniques for collecting payment over the internet (often via a credit or debit card) may be used, as well as wire transfers.

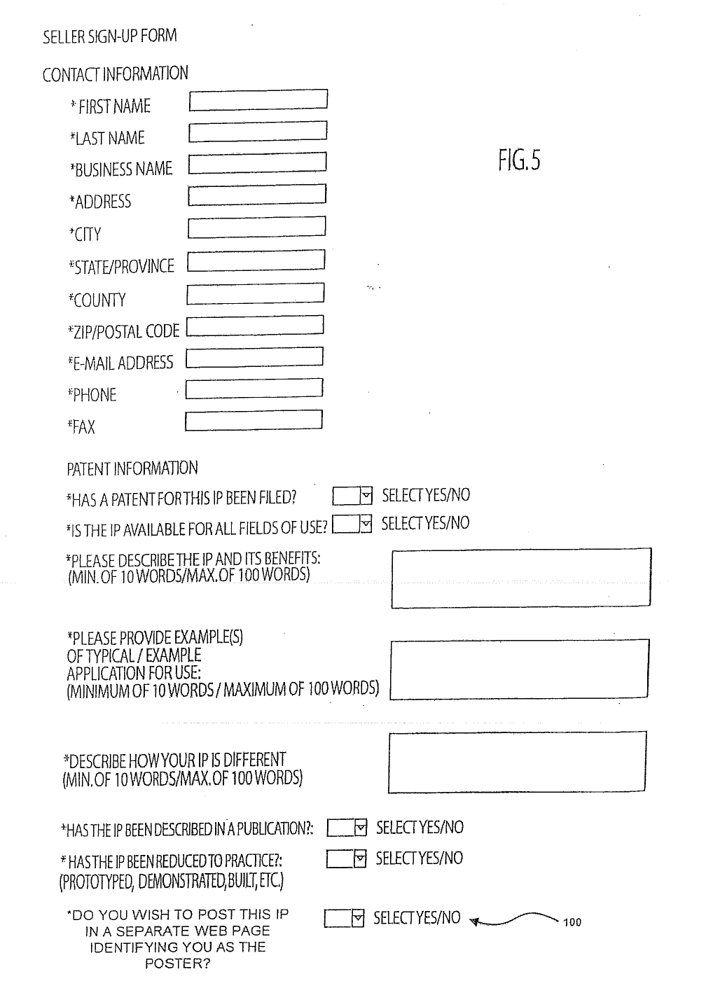

In addition to basic registration, the poster must provide information about the IP to be sold or licensed. This IP information 24 can comprise, for example, the type of IP and its status (utility patent, pending unpublished utility application, trade secret, etc.); a number, if any, such as a publication or registration number; documents uploaded under the guidance of the poster, a field of use available for license, or a geographic region or other territory available for license; and, in accordance with a highly advantageous feature, marketing information. FIG. 5 shows a representative sample sign in form completed by the poster, which is preferably part of the online marketplace website.

Marketing information about the IP assets to be offered for sale or licensed is very important for assets that are described in highly structured legalistic language such as patents. Advantageously, marketing information is provided which helps a potential buyer better understand the scope and strengths of the underlying asset. Marketing information may include, for example, a description of some of the benefits of the IP; a description of how the IP is different from other known technology; a non-technical description of the IP, examples of applications of use, an indication of whether the IP covers a product or process which has been used in production; and whether prototypes have been built. Marketing information also preferably advantageously comprises terms which are used by the marketplace to generate a searchable list of IP assets. A Marketing Abstract can succinctly summarize the advantages and differences of the IP asset. For example the Marketing Abstract can take the form of a short description of the IP and its benefits (technology, field of use, potential market size, estimates of profits, etc.) and a short description of how the IP is different than existing technologies as seen in FIG. 5. Information is provided to the website by the poster via fill-in forms, drop down boxes (such as, for example, the Field of Use boxes shown in FIG. 2), etc., for inputting appropriate information into a website. As noted above, advantageously these IP assets can include non-published and confidential IP. Preferably each field, including keywords, uploaded files, patent PDF documents, any checked boxes, etc., are searchable by those viewing the postings.

When a poster inputs marketing information, the poster has an additional opportunity to segregate its IP from the rest of the IP posted by other posters. This can be done by allowing its IP to be further distinguished by the fact that it was created or is owned by a particular entity. If the poster selects yes to the question 100 at the bottom of FIG. 5 regarding whether the IP being posted should be listed in a separate or single location or web page where only IP from that poster is listed, then a buyer will be able to choose to view only IP from that entity. The poster may modify that web page to make it unique by adding its trademark or logo so that those that view that particular web page will easily identify that the IP listed on the web page (or set of web pages) are being offered by that particular entity. This feature adds value for both the poster and buyer because there may be preexisting relationships that allow the parties (poster and buyer) to more readily come to an agreement on the transfer of rights of the poster's IP to the buyer. Additionally, the reputation of the poster may direct more viewers and buyers to its web pages because it is known for cutting edge research or effectively bring technology to market.

Further, a poster may segregate its IP within its separate web pages by subject matter, key words, or product lines. This will allow someone viewing the separate web page to quickly identify the IP that it would be interested from that particular poster.

Advantageously, this online system helps with rapid dissemination of commercially available IP assets in one convenient location, which can be scrutinized by potential buyers. Without this marketplace, such inventions would be unpublished for at least 18 months after the filing of a patent application, or if published, a would-be poster would have to track down and find a way to direct multiple third parties to his publication(s); clearly a very unappealing and tedious process.

Set Disclosure Level 28. After the poster establishes the IP assets for which rights can be transferred, the poster can set a level of confidentiality within the marketplace and whether to reveal its identity to potential buyers. Thus, the list of IP assets available for license or for purchase is presented to buyers in a controlled format. For example, a trade secret may be presented in summary form, and the identity of the poster may optionally remain confidential between the marketplace operator and the poster—not provided to the buyer.

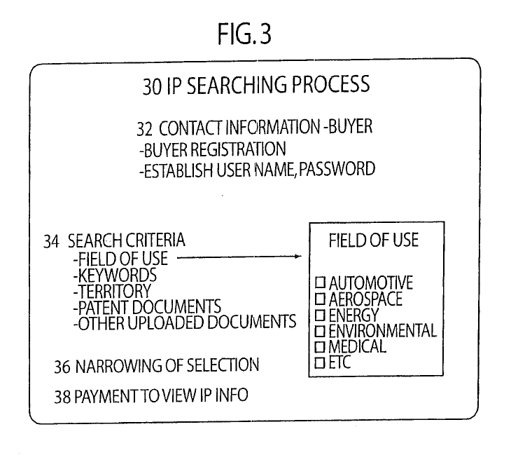

IP Searching Module 30. A potential buyer provides relevant contact information at the Search Module 30 shown in FIG. 3. The buyer completes a Buyer Registration and is issued a username and password in a manner similar to what the poster does to start the process. Preferably information is accessible on the website only after logging in. The first part of the process may be the same, with a user indicating whether they are a buyer or poster of IP. If they are a buyer or potential buyer, the next step would comprise searching for the particular IP. To search for IP assets, fill-in forms, drop down boxes, text search, uploaded documents, etc. are used. As shown in FIG. 3, a Field of Use checklist may be provided, allowing the viewer to make a selection to help identify and locate specific IP assets. The list of available IP based on keyword search terms and other information input by the poster is generated. Further narrowing of the search criteria 36 to hone in on a desired selection may be done as well. Optionally, the buyer may be charged a fee for the privilege of viewing the IP with supporting information including uploaded documents and marketing information available for license or for sale.

In accordance with a preferred embodiment, the resulting list generated for the buyer does not necessarily provide patent or application numbers, patent titles, inventors, or other sensitive information. Non-sensitive information will be provided to indicate the general subject matter and availability of the IP. Thus, in this embodiment, the information is provided to potential buyers in a controlled format. The buyer can then narrow down the search criteria as a means to understand IP availability and specific concept. If the buyer wishes to pursue a listed IP, the buyer may be required to register to view information on the pieces of IP. In some instances, a fee may be assessed against the buyer. If the IP is confidential, the potential buyer will be required to enter into a non-disclosure agreement. In addition, the marketplace can provide for confidentiality of viewers until they elect to establish contact with the poster, either through the website or directly with the poster.

In accordance with a highly advantageous feature, the list of IP assets may be uploaded from a poster or more particularly a poster's website via a transfer of data over the internet. Such data can be in one of several forms. For example, the data may be uploaded manually from a poster or more particularly a poster's website via a transfer of data over the internet. Alternatively, the data can comprise an extensible markup language (XML) which is good for the transfer of structured data over the internet, or comma separated values (CSV), which is good for handling data transfers over the internet in tabular form. Other suitable programs, languages and file formats suitable for data transfer from the poster will be readily apparent to those skilled in the art given the benefit of this disclosure.

The buyers, whether they buy or view the IP, are identifiable by the method because they have to register prior to viewing assets. The information of the buyer will be made available to the poster, either in precise form or in summary form, depending on the way the buyer registers, i.e., whether or not it wants its information to be made public or not. This ability to share information, either direct information or summary information, to the poster is valuable information to the poster. The poster may determine that other IP may be of value to the class of buyers looking at the information and may determine to post those other IP assets. When the buyer determines it is willing to negotiate for rights in any of the IP, the identity of the buyer will be made available to the poster.

At registration, preferably both the poster and potential buyer enter into the Listing/Buying contract with the online marketplace operator. The Listing/Buying contract may require the posters agree to post their information in a redacted (controlled) format where patent or patent application numbers, patent titles, inventors, or other identification information which identifies the asset or the owner of the asset are not provided to the buyers and potential buyers. Each Listing/Buying contract can also optionally include conditions requiring exclusive use of the online marketplace for completing a transaction (purchase or license) of the IP from the poster to the buyer. The online marketplace operator may charge a fee for each such completed transaction.

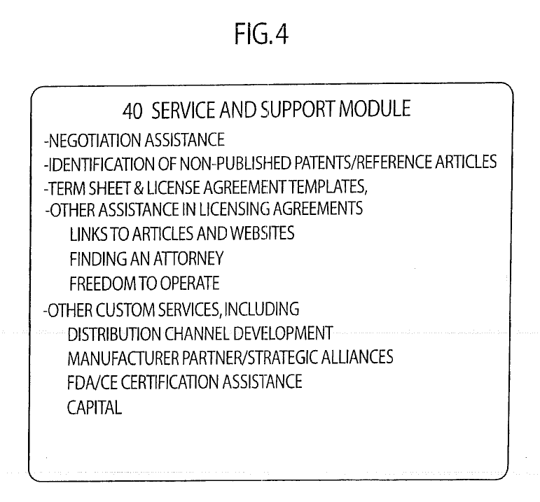

Service and Support Module 40. Buying and selling of IP often is a complicated transaction, especially given the uniqueness of such assets. Therefore additional support is offered by the marketplace operator on the website at a Support Module 40 accessible by both the posters and by viewers/potential buyers and shown in FIG. 4. This support can comprise one or more of several items, including, for example, negotiation assistance; identification of other non-published patents and reference articles; links to support service organizations, such as a partner's network; help finding IP attorneys and preparation of freedom to operate opinions; assistance finding distribution channels (for new licensees); assistance finding contract manufacturers (for new licensees); assistance creating strategic alliances; FDA/CE certification assistance (with IP pertaining to drugs and medical devices); other regulatory assistance; assistance in finding financing, etc. Other useful services and resources such as license agreement templates and links to other websites may be provided and will be readily apparent to those skilled in the art given the benefit of this disclosure.

Fees may be charged by the marketplace operator at various steps in the process, including:

1. A fee may be charged each poster for posting IP to the online marketplace (Posting Fee). The posting fee can be zero, or set for a limited period of time, or unlimited.

2. A fee may be charged each viewer of the selected IP (Buyer/Potential Buyer/Viewing Fee). The fee can be zero, or a fee for an unlimited number of views for a period of time, or a per view fee.

3. A fee may be charged by the website operator any time an agreement is completed between two parties who entered into a listing and buying contract (Selling fee).

4. Advertising fees may be charged such as banner advertisements or sponsorships on the website.

5. Consulting fees, either by the marketplace operator or by an affiliated entity.

In addition, the website developer may provide other services to the posters and to the buyers. Not all of the fees need necessarily be charged. For example, a more open system could charge a posting fee, but waive the viewing fee and the selling fee. In this method of selling IP assets via an online marketplace, the controlled format of presentation of information to the buyers and potential buyers would include, for example, contact information of the poster and identification numbers for the IP assets, where applicable. Other variations of fee arrangements will be readily apparent to those skilled in the art given the benefit of this disclosure.

The poster of IP may wish to see what viewers are looking at its IP, or have signed their non-disclosure agreement etc. In accordance with a highly advantageous feature, the poster may set alert criteria wherein the poster is alerted when an event occurs preselected by the poster, or simply view a log of such activities. The alert can comprise for example, an e-mail or text message which includes information such as for example the number of views of any particular IP posted, and the number of different views by individual viewers. Additional alert information will be readily apparent to those skilled in the art given the benefit of this disclosure. The alert criteria may comprise information pertaining to the list of IP, such as when a viewer looks at the poster's IP, signs a non-disclosure agreement, etc., and may also include a preselected period of time.

In a similar manner, the viewer of the IP assets may by interested in being alerted when IP assets appear that meet the viewer's preferences. The alert criteria used may be set by information pertaining to the list of IP, including keywords such as those used in the search criteria mentioned above, (inventor, technology) for example, or another field of use related to the IP assets the viewer is interested in viewing. As with the poster alert, the viewer alert can comprise for example, an e-mail or text message for example. Other alert criteria for both posters and for viewers will be readily apparent to those skilled in the art given the benefit of this disclosure.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A method for creating a marketplace for a plurality of intellectual property assets defined by a number of characteristics, the method comprising the steps of:
receiving a portion of the plurality of intellectual property assets;
associating each of the plurality of intellectual property assets with a poster;
identifying a portion of the characteristics for the portion of the plurality of intellectual property assets;
modifying the characteristics of the portion of the plurality of intellectual property assets to create marketing information; and
posting the marketing information for the portion of the plurality of intellectual property assets in a single location such that a buyer interested in obtaining rights in any of plurality of the intellectual property assets may view the plurality of intellectual property assets by marketing information.

2. A method as set forth in claim 1 including the step of providing an agreement to allow the buyer interested in an intellectual property asset to enter into an obligation of confidentiality.

3. A method as set forth in claim 2 including the step of providing access to the buyer interested in the intellectual property asset to have access to any confidential information related to the intellectual property asset.

4. A method as set forth in claim 1 including the step of providing access to the poster of the buyer interested in the intellectual property asset to transfer rights in the intellectual property asset from the poster of the intellectual property asset to the party interested therein.

5. A method as set forth in claim 4 including the step of collecting party information characterizing qualities relating to the buyer interested in the intellectual property asset.

6. A method as set forth in claim 5 including the step of transferring the buyer information into summary information.

7. A method as set forth in claim 6 including the step of providing access of the summary information to the poster.

8. A method as set forth in claim 1 including the step of creating a database of the marketing information for the. plurality of intellectual property assets.

9. A method as set forth in claim 8 including the step of allowing the marketing information to be key word searched.

10. A method as set forth in claim 1 wherein the step of receiving the portion of intellectual property assets includes the step of receiving the portion of intellectual property assets independent of format.

11. A method for creating a marketplace for a plurality of intellectual property assets defined by a number of characteristics, the method comprising the steps of:
receiving a portion of the plurality of intellectual property assets independent of format;
creating a database of the marketing information for the plurality of intellectual property assets;
identifying a portion of the characteristics for the portion of the plurality of intellectual property assets;
modifying the characteristics of the portion of the plurality of intellectual property assets to create marketing information; and
posting the marketing information for the portion of the plurality of intellectual property assets such that a party interested in obtaining rights in any of plurality of the intellectual property assets may view the plurality of intellectual property assets by marketing information.

12. A method as set forth in claim 11 including the step of alerting the poster in response to the buyer viewing one or more of the portion of intellectual property assets.

13. The method of claim 12 including the step of notifying the buyer when the poster posts an additional intellectual property asset containing information relating to subject matter of interest to the buyer.

14. The method as set forth in claim 13 wherein the information includes search terms utilized by the buyer.
